(19) United States
(12) Patent Application Publication
(10) Pub. No.: US 2005/0246298 A1
(43) Pub. Date: Nov. 3, 2005

(54) Device for context-dependent data analysis

(75) Inventors: Rita Almeida, Barcelona (ES); Gustavo Deco, Vilassar de Mar (ES); Martin Stetter, Munich (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 11/085,472

(22) Filed: Mar. 22, 2005

(30) Foreign Application Priority Data
Mar. 22, 2004 (DE) 10 2004 013 924.5

(51) Int. Cl. G06E 1/00

(52) U.S. Cl. 706/16

(57) ABSTRACT

A device for context-dependent data analysis has a plurality of neurons which are combined to form a plurality of neuron pools. The weights of the links between two neurons are a function of the neuron pools to which the two neurons belong.

### CROSS REFERENCE TO RELATED APPLICATIONS

This application is based on and hereby claims priority to German Application No. 10 2004 013 924.5 filed on Mar. 22, 2004, the contents of which are hereby incorporated by reference.

### BACKGROUND OF THE INVENTION

1. Field of the Invention

The invention relates to a device for context-dependent data analysis.

2. Description of the Related Art

In many technical areas data is analyzed in relation to a context, in which the data occurs or is used. For example the settings of a production device in a production plant can be specified by parameter values. If the production device is used to produce different products, the production device must typically be set differently for different products.

This means that for example a first set of parameter values exists, which specifies the settings of the production device, which are required for the production of a first product, and a second set of parameter values exists, which specifies the settings of the production device, which are required for the production of a second product. These two sets of parameter values together form a data set.

If the first product is to be produced, the production device must be set according to the settings required for the production of the first product, in other words it must be set so that the production device operates such that the first product can be produced. The required settings must be obtained from the data set for this purpose.

To this end it must be identified that the first set of parameter values has to be selected from the data set, as this specifies the settings of the production device required for the production of the first product. Selection of the parameter set is therefore a function of the product to be produced.

The product to be produced can be seen as a context for the use of the data set. In this case the data set must be analyzed with respect to the context, in which the data is used, so that the settings required for the production of the first product can be determined. The analysis of data with respect to a context, in which the data occurs or is used, is referred to below as context-dependent data analysis.

A further example of context-dependent data analysis occurs with the control of a storage module, in which data is stored or not stored as a function of its relevance. Data which is soon to be reused can for example have high relevance, while data which will not be used for a long time for example has low relevance.

It is, for example, expedient for the efficient running of a computer program only to buffer such data in a cache of the computer running the computer program as will soon be reused during the running of the computer program (i.e. after few clock cycles). In this example the data is analyzed in the context of the computer program being run and data which has high relevance in this context is selected for buffering.

A further example of context-dependent data analysis is the analysis of data that exists in the form of time series. In this instance the context is determined by the data preceding the data to be analyzed currently.

A standard method for implementing a context-dependent data analysis is the use of a table. In the above example of the production device, which is used to produce two different products, a production engineer, who sets the settings, could for example have a table, which has a first entry, which contains the information that settings of the production device according to the first set of parameter values are required to produce the first product, and which has a second entry, which contains the information that settings of the production device according to the second set of parameter values are required to produce the second product.

This method has the disadvantage that a corresponding table has to be produced. The production of a table can require a significant outlay, if the number of different contexts and the data set are large.

In the above example settings of the production device according to a third set of parameter values could for example be required, if the first product is to be produced in a non-standard color and settings of the production device according to a fourth set of parameters could be required, if the first product is to be produced in the standard color but is to be rather wider than standard.

As the number of different products that can be produced increases, so too does the number of sets of parameter values, as the production device has to be set to produce different products according to different sets of parameter values. The number of different products can for example be increased by increasing the number of combinations of possible features that the products can have. For example it can be possible for the products to be produced in three different colors and three different widths rather than two different colors and two different widths, with the result that a larger number of different parameter sets is required. The size of the table used to select the parameter set required for the correct setting of the production device according to the above method also increases correspondingly.

In addition to the large amount of time required to generate a large table, it is a disadvantage of the above method that significant outlay is required to store a large table. If the table is stored electronically for example on a computer-readable storage medium, a great deal of space is required on the computer-readable storage medium.

The use of neural networks for production processes is known from DE 196 43 884 C2. The formation of neuron pools is known from EP 1 327 959 A2 and U.S. Pat. No. 6,434,541 B2.

### SUMMARY OF THE INVENTION

An object of the invention is to provide a device for context-dependent data analysis, with which context-dependent data analysis can be carried out efficiently and with little storage outlay.

A device is provided for context-dependent data analysis with the following features:

a context module with a plurality of artificial neurons, which are grouped to form a plurality of context neuron pools, to which one or a plurality of context-dependent input objects are respectively assigned;

with an output module with a plurality of artificial neurons, which are grouped to form a plurality of output neuron pools, to which one or a plurality of output objects are respectively assigned; and

with a combinational logic module with a plurality of artificial neurons, which are grouped to form a plurality of combination logic neuron pools, to which one or a plurality of context-independent input objects are assigned,

each combination logic neuron pool having at least one neuron, which is linked to at least one neuron from a context neuron pool;

each combinational logic neuron pool having at least one neuron, which is linked to at least one neuron from an output neuron pool;

the weights of the links between neurons from different context neuron pools being less than the weights of the links between neurons from the same context neuron pool;

the weights of the links between neurons from different output neuron pools being less than the weights of the links between neurons from the same output neuron pool; und

the weights of the links between neurons from different combinational logic neuron pools being less than the weights of the links between neurons from the same combinational logic neuron pool.

The device for context-dependent data analysis can be used for many applications.

As well as use in a production plant for the correct setting of production devices and use as a control device of a storage module according to the two examples above, it is suitable for example

for the analysis of data, which exists in time series, for example financial data;

for process control;

for use in robotics;

for medical applications.

A plurality of further possible applications of the device for context-dependent data analysis are evident to the person skilled in the art.

With the device for context-dependent data analysis it is preferred that each link between a neuron from a combinational logic neuron pool and a neuron from a context neuron pool also has a weight that is less than the weights of the links between neurons from the same context neuron pool or combinational logic neuron pool.

With the device for context-dependent data analysis it is also preferred that each link between a neuron from a combinational logic neuron pool and a neuron from an output neuron pool has a weight that is less than the weights of the links between neurons from the same combinational logic neuron pool or output neuron pool.

In a preferred embodiment, assignment between the combinational logic neuron pools and the context-independent input objects is achieved by distributed representation. This means that not every context-independent input object is assigned to just one combinational logic neuron pool and represented by a state of this combinational logic pool but that an input object is assigned to a plurality of combinational logic pools and represented by a combination of states of the combinational logic pools. For example the device for context-dependent data analysis has two combinational logic neuron pools, each with a plurality of neurons, which can assume two states as a function of neuron activity.

It is therefore possible to assign each of four context-independent input objects to the four different combinations of the states of the two combinational logic neuron pools and it is possible for each of the four context-independent input objects to be represented by one of the four different combinations of the states of the two combinational logic neuron pools. By using distributed representation it is possible to keep the storage requirement of the device for context-dependent data analysis small.

With the device provided for context-dependent data analysis it is preferred that the device for context-dependent data analysis also has a plurality of neurons, which are grouped to form an inhibitory neuron pool, the neurons acting in an inhibitory manner on all the other neurons of the device for context-dependent data analysis, in other words the output pulses of the neurons from the inhibitory neuron pool reduce the potential of the neurons linked on the output side to the neurons from the inhibitory neuron pool.

With the device provided for context-dependent data analysis it is also preferred that the device for context-dependent data analysis also has a plurality of neurons, which are grouped to form a non-selective neuron pool.

With the device provided for context-dependent data analysis it is also preferred that the weights of the links of the neural network are determined by a Hebbs' learning rule.

In a preferred embodiment, each context-independent input object is a set of parameter values, which specifies the settings of a production device required for the production of a product, each context-dependent input object specifies a product and the device for context-dependent data analysis is used to control the production device.

### BRIEF DESCRIPTION OF THE DRAWINGS

These and other objects and advantages of the present invention will become more apparent and more readily appreciated from the following description of exemplary embodiments, taken in conjunction with the accompanying drawings of which:

FIG. 1 is a block diagram of a system for context-dependent data analysis according to one embodiment of the invention.

FIG. 2 is a data flow diagram illustrating the data flow in one embodiment of the invention.

FIG. 3 1 is a block diagram of a device for context-dependent data analysis according to one embodiment of the invention.

FIG. 4 is an illustration of data states showing the response of a neural network according to one embodiment of the invention.

FIGS. 5A, 5B, 5C are graphs of the response of a neural network according to one embodiment of the invention.

FIG. 6 is a graph of the response of a neural network according to one embodiment of the invention.

FIGS. 7A, 7B, 7C, 7C are graphs illustrating the dynamic of a neural network according to one embodiment of the invention.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

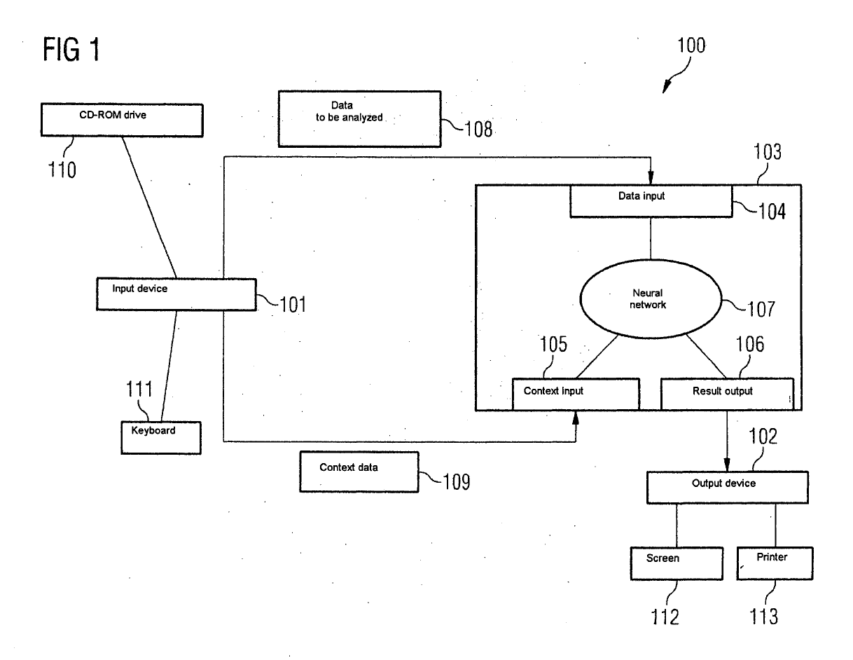

FIG. 1 shows a system for context-dependent data analysis 100 according to one embodiment of the invention. The system for context-dependent data analysis 100 has an input device 101, an output device 102 and a device for context-dependent data analysis 103. The device for context-dependent data analysis 103 has a data input 104, a context input 105 and a result output 106, which are linked by a neural network 107.

A user can use the input device 101 to input data to be analyzed 108 and context data 109. The input device is linked to a CD-ROM drive 110, which a user can use to read data to be analyzed 108 and context data 109 from a CD-ROM and feed it to the input device 101. The input device is also linked to a keyboard 111, which a user can user to input data to be analyzed 108 and context data 109 into the input device 101.

The data to be analyzed 108 is fed to the data input 104 of the device for context-dependent data analysis 103. Die context data 109 is fed to the context input 105 of the device for context-dependent data analysis 103.

The device for context-dependent data analysis 103 uses the neural network 107 to analyze the data to be analyzed 108 with respect to a context, which is specified by the context data 109. The result of this context-dependent data analysis is fed via the result output 106 to an output device 102. The output device 102 is linked to a screen 112, by which the result of the context-dependent data analysis can be displayed. The output device 102 is also linked to a printer 113, by which the result of the context-dependent data analysis can be printed out.

Use of the system for context-dependent data analysis 100 is described below.

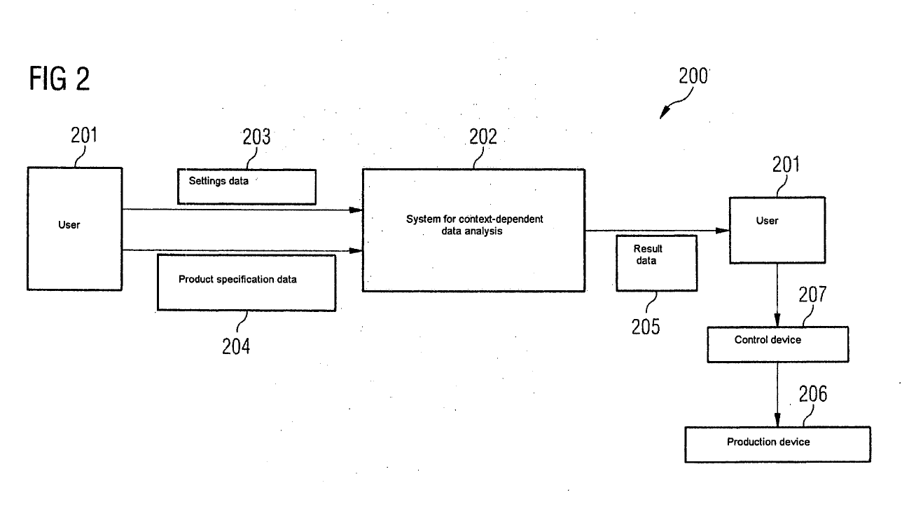

FIG. 2 shows a data flow diagram 200 illustrating the data flow in one embodiment of the invention. The data flow diagram 200 shows the data flow in a system for context-dependent data analysis according to one embodiment of the invention, as used in a production plant.

This embodiment of the invention corresponds to the example mentioned above, in which data containing information about the settings of a production device in a production plant required for the production of a specific product to be produced is analyzed as a function of the product to be produced.

The data flow shown in the data flow diagram 200 takes place between a user 201, a system for context-dependent data analysis 202 and a control device 207. In this embodiment the system for context-dependent data analysis 202 is the system for context-dependent data analysis 100 shown in FIG. 1. Accordingly reference is made below in the description of the data flow shown in the data flow diagram 200 to FIG. 1 and FIG. 2.

The system for context-dependent data analysis 202 is used in this embodiment in a production plant (not shown). The production plant has a production device 206. The production device 206 can implement production steps for producing products, which are a function of the product to be produced.

Specific settings must be set on the production device, so that the production device implements a specific production step, which is required for the production of a specific product. These settings are referred to below as the settings required for the production of a product. The settings required for the production of a specific product can be specified by a set of (production) parameter values. This set of parameter values is referred to below as the set of parameter values corresponding to the product.

The user has settings data 203, which contains information for every product that can be produced using the production device 206 about the settings required for the production of the product. The user 201 also has product specification data specifying a product to be produced. A product may be a chair of a specific color for example, of a specific size and with a specific chair-back design.

Corresponding settings have to be set on the production device 206 so that the production device 206 implements the production step required for the production of the specified product. For example a switch on the production device must be set such that color from a specific color tank is used, so that the chair is produced in the color specified by the production specification data 204.

To be able to set the corresponding settings, the set of parameter values corresponding to the product specified by the production specification data 204 must be determined from the settings data 203. To this end the product specification data 204 is fed via the context input 105 and the settings data 203 via the data input 104 to the system for context-dependent data analysis 202. The system for context-dependent data analysis 202 uses the neural network 107 to determine the set of parameter values corresponding to the product specified by the production specification data 204 and outputs this as result data 205 via the result output 106 to the user 201. The user 201 sets the settings required for the production of the product specified by the production specification data 204, which are specified by the result data 205, by a control device 207, which controls the production device 206.

In another embodiment the result data 205 is not output to the user 201 but is fed via the output device 102 directly to the control device 207, which controls the production device 206. The control device 207 then sets the settings of the production device 206 specified by the result data, by controlling the production device 207 accordingly.

In another embodiment data containing information about the required settings of a production device is not analyzed but data containing information about which production parameters are particularly important for the production of products is analyzed, so that a high quality can be achieved. Accordingly with this embodiment the system for context-dependent data analysis 202 outputs result data containing information about which production parameters are particularly important for the production of a specific product to be produced, so that a high quality can be achieved.

The mode of operation of a device for context-dependent data analysis according to a further embodiment is described below.

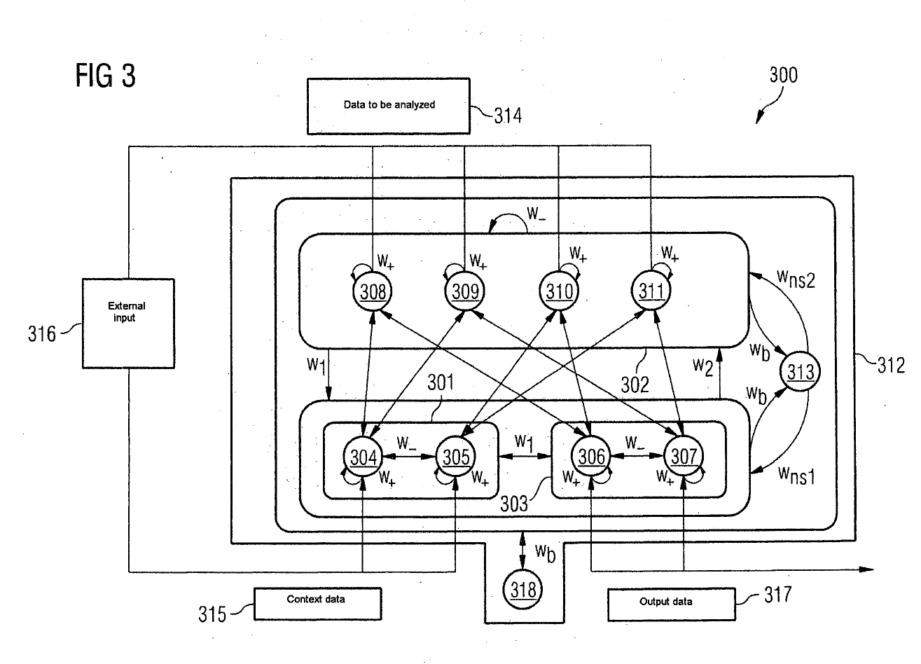

FIG. 3 shows the device for context-dependent data analysis 300 according to one embodiment of the invention. For the purposes of simplification only context data 315 for distinguishing between two different contexts can be input into the device for context-dependent data analysis 300. This means that the device for context-dependent data analysis 300 is fed context data 315 containing the information that a first context or a second context is present. Similarly the device for context-dependent data analysis 300 outputs output data 317, which only contains two different information elements. This means that the device for context-dependent data analysis 300 outputs output data 317, which either contains the information that a first analysis result is present or contains the information that a second analysis result is present.

In an embodiment described with reference to FIG. 1 and FIG. 2 for example the first context could be that a first product is to be produced and the second context that a second product is to be produced. The first analysis result could for example be that a specific switch on the production device 206 must be moved to position “A” and the second analysis result could for example be that the specific switch on the production device 206 must be moved to position “B”.

In the exemplary embodiment described below the first context corresponds to a first object and the second context corresponds to a second object. The first analysis result corresponds to a first location and the second analysis result corresponds to a second location.

For example data to be analyzed 314 is fed to the device for context-dependent data analysis 300 containing the information that a first object is in a first position and a second object in a second position. If context data 315 specifying the first object is also fed in, the device for context-dependent data analysis 300 outputs output data 317 specifying the first location. This can for example be interpreted such that the first object is considered to be of high relevance and that the location of the first object is therefore to be output.

The device for context-dependent data analysis 300 has three modules: a context module 301, a combinational logic module 302 and an output module 303.

The term “neuron pool” below refers to a group of neurons with at least one neuron. The context module 301 has a first context neuron pool 304 and a second context neuron pool 305. The output module 303 has a first output neuron pool 306 and a second output neuron pool 307. The combinational logic module 302 has a first combinational logic neuron pool 308, a second combinational logic neuron pool 309, a third combinational logic neuron pool 310 and a fourth combinational logic neuron pool 311.

In this exemplary embodiment the neurons are leaky integrate and fire neurons, hereafter referred to as IF neurons. An IF neuron can be described as a switching circuit, which has a capacitor of capacity Cₘ, which corresponds to the cell membrane capacity of a biological neuron, and a resistance Rₘ, which is connected in parallel to the capacitor. An IF neuron is excited by the firing of neurons, which are linked to the neuron in an excitatory manner, in other words the potential of the neuron is increased by the firing of neurons linked to the neuron in an excitatory manner. An IF neuron is inhibited by the firing of neurons, which are linked to the neuron in an inhibitory manner, in other words the potential of the neuron is reduced by the firing of neurons linked to the neuron in an inhibitory manner.

The capacitor of the IF neuron is clearly charged by input currents of excitatory neurons and discharged by input currents of inhibitory neurons. If the potential of the neuron, specifically the capacitor voltage, exceeds a specific threshold, the neuron fires, in other words the switching circuit short circuits. The firing of the neuron changes the potential of the neurons linked to the neuron on the output side.

The device for context-dependent data analysis 300 has N_{E}=1600 excitatory neurons (excitatory pyramid cells) and N_{I}=400 inhibitory neurons (interneurons). Excitatory neurons are linked to other neurons such that they have an excitatory influence on the other neurons and inhibitory neurons are linked to other neurons such that they have an inhibitory influence on the other neurons.

The neurons of the device for context-dependent data analysis 300 form a neural network 312. The neural network 312 of the device for context-dependent data analysis 300 is fully connected. The mathematical formulation for IF neurons and synaptic currents used in this exemplary embodiment is described below. The formulation is based on the formulation described in Brunel N. & Wang X. J., “Effects of Neuromodulation in a Cortical network model of Object working memory dominated by Recurrent inhibition”, Comput. Neurosci., 2001, vol. 11, pages 63-85.

The dynamic of the membrane potential V of a neuron, the membrane potential being below the potential threshold of the neuron, is given by the equation

$${C}_{m} \frac{ⅆ V ( t )}{ⅆ t} = - {g}_{m} ( V ( t ) - {V}_{L} ) - {I}_{syn} ( t ) \qquad ( 1 )$$

where Cₘ is the membrane capacity, which is 0.5 nF for excitatory neurons and 0.2 nF for inhibitory neurons. gₘ is the membrane leak conductance, which is 25 nS for the excitatory neurons and 20 nS for the inhibitory neurons. V_{L} is the rest potential and is t−70 mV and I_{syn} is the synaptic current. The potential threshold is Vᵣ=−50 mV and the reset potential Vᵣₑₛₑₜ, which is the potential of a neuron immediately after firing, is −55 mV.

The synaptic current of a neuron is given by the sum of four currents:
I_{syn}(t)=I_{AMPA,ext}(t)+I_{AMPA,rec}(t)+I_{NMDA,rec}(t)+I_{GABA}(t) (2)
where

$${I}_{AMPA , ext} ( t ) = {g}_{AMPA , ext} ( V ( t ) - {V}_{E} ) {\sum }_{j = 1}^{{N}_{ext}} {s}_{j}^{AMPA , ext} ( t ) , \qquad ( 3 )$$

which can be interpreted as an AMPA-mediated, external excitatory current;

$${I}_{AMPA , rec} ( t ) = {g}_{AMPA , rec} ( V ( t ) - {V}_{E} ) {\sum }_{j = 1}^{{N}_{E}} {w}_{j} {s}_{j}^{AMPA , rec} ( t ) , \qquad ( 4 )$$

which can be interpreted as a glutamatergic, AMPA-mediated, recurrent, excitatory current;

$${I}_{NMDA , rec} ( t ) = \frac{{g}_{NMDA} ( V ( t ) - {V}_{E} )}{1 + [ {Mg}^{++} ] exp ( - 0 \text{,} 062 V ( t ) ) / 3 \text{,} 57} \times {\sum }_{j = 1}^{{N}_{E}} {w}_{j} {s}_{j}^{NMDA} ( t ) , \qquad ( 5 )$$

which can be interpreted as a glutamatergic, NMDA-mediated, recurrent, excitatory current; and

$${I}_{GABA} ( t ) = {g}_{GABA} ( V ( t ) - {V}_{I} ) {\sum }_{j = 1}^{{N}_{I}} {s}_{j}^{GABA} ( t ) , \qquad ( 6 )$$

which can be interpreted as an inhibitory, GABAergic current.

Hereby V_{E}=0 mV, V_{I}=−70 mV, wⱼ being the synaptic weights of the neurons linked in an excitatory manner to the neuron on the input side. As mentioned above, the device for context-dependent data analysis has N_{E}=1600 excitatory neurons.

Nₑₓₜ can be interpreted as the number of a plurality of external neurons, i.e. neurons, which are not part of the neural network 312 but which are linked to neurons from the neural network 312. In this exemplary embodiment Nₑₓₜ=800.

I_{NMDA,rec}(t) is a function of the potential and [Mg^{++]=}1 mM, which can be interpreted biologically as the concentration of magnesium outside the neuron.

Also in this exemplary embodiment for an excitatory neuron g_{AMPA,ext}=2,08 nS, g_{AMPA,rec}=0,052 nS, g_{NMDA}=0,1635 nS, and g_{GABA}=0,625 nS and for an inhibitory neuron g_{AMPA,ext}=1,62 nS, g_{AMPA,rec}=0,0405 nS, gNMDA =0,129nS, and g_{GABA}=0,4865 nS. These values can be interpreted as the synaptic conductance of the channels of the different receptors.

The variables

$${s}_{j}^{AMPA , ext} ( t ) , {s}_{j}^{AMPA , rec} ( t ) , {s}_{j}^{NMDA} ( t ) and {s}_{j}^{GABA} ( t )$$

can be interpreted as the fraction of the open channels for the different receptors and are determined by

$$\begin{matrix}\frac{ⅆ {s}_{j}^{AMPA , ext} ( t )}{ⅆ t} = - \frac{{s}_{j}^{AMPA , ext} ( t )}{{τ}_{AMPA}} + {\sum }_{k} δ ( t - {t}_{j}^{k} ) & ( 7 ) \\ \frac{ⅆ {s}_{j}^{AMPA , rec} ( t )}{ⅆ t} = - \frac{{s}_{j}^{AMPA , rec} ( t )}{{τ}_{AMPA}} + {\sum }_{k} δ ( t - {t}_{j}^{k} ) & ( 8 ) \\ \frac{ⅆ {s}_{j}^{NMDA} ( t )}{ⅆ t} = - \frac{{s}_{j}^{NMDA} ( t )}{{τ}_{NMDA , decay}} + α {x}_{j} ( t ) ( 1 - {s}_{j}^{NMDA} ( t ) ) & ( 9 ) \\ \frac{ⅆ {x}_{j} ( t )}{ⅆ t} = - \frac{{x}_{j} ( t )}{{τ}_{NMDA , rise}} + {\sum }_{k} δ ( t - {t}_{j}^{k} ) & ( 10 ) \\ \frac{ⅆ {s}_{j}^{GABA} ( t )}{ⅆ t} = - \frac{{s}_{j}^{GABA} ( t )}{{τ}_{GABA}} + {\sum }_{k} δ ( t - {t}_{j}^{k} ) & ( 11 )\end{matrix}$$

where τ_{NMDA,decay}=100 ms, τ_{AMPA}=2 ms, τ_{GABA}=10 ms, τ_{NMDA,rise}=2 ms and α=0,5 ms⁻¹.

The above formulae can be interpreted such that the signal rise times for AMPA and GABA are ignored because they are less than 1 ms. The sums over k represent sums over output pulses, which are formulated as δ pulses and are emitted by a presynaptic neuron j at a time tⱼ^{k}. The weights of the links between the neurons of the neural network 312 are selected as different, so that the neural network 312 has a suitable structure. Selection of the weights of the links of the neural network 312 allows the neural network 312 to be set up such that it implements a so-called modular biased competition and cooperation paradigm.

The first context neuron pool 304, the second context neuron pool 305, the first output neuron pool 306, the second output neuron pool 307, the first combinational logic neuron pool 308, the second combinational logic neuron pool 309, the third combinational logic neuron pool 310 and the fourth combinational logic neuron pool 311 together form eight so-called selective neuron pools, each of which comprises a fraction f of the total number of excitatory neurons, i.e. fN_{E} neurons.

The neural network 312 also has a pool of non-selective neurons 313, which is formed by all excitatory neurons, which do not belong to one of the eight selective pools. The pool of non-selective neurons therefore has a number of (1-8 fN_{E} neurons.

The neural network also has an inhibitory neuron pool 318 with the N₁ inhibitory neurons. In this exemplary embodiment f=0,05.

The first combinational logic neuron pool 308, the second combinational logic neuron pool 309, the third combinational logic neuron pool 310 and the fourth combinational logic neuron pool 311 correspond to the data to be analyzed 314. The first combinational logic neuron pool 308 corresponds to the information that the first object is at the first location. The second combinational logic neuron pool 309 corresponds to the information that the first object is at the second location. The third combinational logic neuron pool 310 corresponds to the information that the second object is at the first location. The fourth combinational logic neuron pool 311 corresponds to the information that the second object is at the second location.

The data to be analyzed 314 is fed via the four combinational logic neuron pools 308, 309, 310, 311 to the device for context-dependent data analysis 300 by an external input 316, as described below.

The first context neuron pool 304 and the second combinational logic neuron pool 305 correspond to the context data 315. The first context neuron pool 304 corresponds to the information that the context is defined by the first object. The second context neuron pool 305 corresponds to the information that the context is defined by the second object. The context data 315 is fed via the two context neuron pools 304, 305 to the device for context-dependent data analysis 300 by an external input 316, as described below.

An external input 316, i.e. an input from outside the network, is fed to each neuron of the neural network 312. The external input 316 fed to a neuron has different components depending on the neuron pool, to which the neuron belongs. The external input 316 is modeled as a Poisson spike train of pulses with a frequency that is a function of the components supplied.

The first component of the external input 316 corresponds to a background activity of Nₑₓₜ external neurons. This component is selected such that it corresponds to a fire rate of 3 Hz of the external neurons. Thus the first component of the external input 316 corresponds to a frequency of 800*3 Hz=2,4 kHz.

The first component of the external input 316 is fed to all the neurons of the neural network 312. The second component of the external input 316 is used to input the data to be analyzed 314 to the device for context-dependent data analysis 300. The second component is only fed to the neurons from a combinational logic neuron pool 304, 305, which corresponds to an information element contained in the data to be analyzed 314. For example the data to be analyzed 314 contains the information that the first object is at the second location and the second object is at the first location.

The information that the first object is at the second location corresponds, as described above, to the second combinational logic neuron pool 309. The information that the second object is at the first location corresponds, as described above, to the third combinational logic neuron pool 310.

When inputting the data to be analyzed 314 in this example, the second component of the external input 316 is thus fed to the second combinational logic neuron pool 309 and the third combinational logic neuron pool 311.

As the first component of the external input 316 is fed to each neuron of the neural network 312, the first component and the second component of the external input are thus fed in this example to a neuron, which is part of the second combinational logic neuron pool 309 or part of the third combinational logic neuron pool 310.

The second component corresponds to a frequency λₛₜᵢₘ. The first component corresponds, as described above, to a frequency of 2.4 kHz. If the first component and the second component of the external input are fed to a neuron, overall the neuron is supplied with an external input in the form of a Poisson spike train with a frequency of 2.4 kHz+λₛₜᵢₘ.

The third component of the external input 316 is used to input the context data 315 to the device for context-dependent data analysis 300. The second component is only fed to neurons from a context neuron pool 308, 309, 310, 311, which corresponds to a context information element contained in the context data 315.

For example the context data 315 contains the information that the context is defined by the first object. The information that the context is defined by the first object corresponds, as described above, to the first context neuron pool 304. When inputting the context data 304 in this example, the third component of the external input 316 is thus fed to the first context neuron pool 304

As the first component of the external input 316 is fed to each neuron of the neural network 312, the first component and the third component of the external input are thus fed in this example to a neuron, which is part of the first context neuron pool 304.

The third component corresponds to a frequency λ_{bias}. The first component corresponds, as described above, to a frequency of 2.4 kHz. If the first component and the third component of the external input are fed to a neuron, overall the neuron is supplied with an external input in the form of a Poisson spike train with a frequency of 2.4 kHz+λ_{bias}.

The structure and function of the neural network 312 are achieved by selecting different weights for the links between the neurons. These weights are determined permanently, in one exemplary embodiment by a learning method, for example using a Hebbs' learning rule.

The neurons in the same neuron pool should activate each other significantly, so the weight w+, which is the weight of the links between neurons from the same neuron pool 304 to 311, 313, 314, is greater than the mean weight w_{b}=1. The interactions between different selective neuron pools 304 to 311 are determined by the weights of the links between them. The weights w′ of the links between neurons from two different neuron pools, the neuron pools corresponding to the same object or the same location, have a value between w_{b} and w₊.

The neuron pools correspond to objects and locations as follows. The first context neuron pool 304, the first combinational logic neuron pool 308 and the second combinational logic neuron pool 309 correspond to the first object. The second context neuron pool 305, the third combinational logic neuron pool 310 and the fourth combinational logic neuron pool 311 correspond to the second object. The first output neuron pool 306, the first combinational logic neuron pool 308 and the third combinational logic neuron pool 310 correspond to the first location. The second output neuron pool 305, the second combinational logic neuron pool 309 and the fourth combinational logic neuron pool 311 correspond to the second location.

The weights w_ of links between neurons from selective neuron pools, which correspond to the same type of information, are selected as less than w_{b}. This is clearly intended to cause these neuron pools to be in dispute with each other and not to activate each other but to demonstrate counter-activity.

The first context neuron pool 304 and the second context neuron pool 305 correspond to the same type of information, object information. Also the first output neuron pool 306 and the second context neuron pool 307 correspond to the same type of information, location information. Also the first combinational logic neuron pool 308, the second combinational logic neuron pool 309, the third combinational logic neuron pool 310 and the fourth combinational logic neuron pool 311 correspond to the same type of information, information about a combination of object and location.

The links from a neuron from the non-selective neuron pool 313 to another neuron of the neural network 312 and the links between a neuron from the inhibitory neuron pool 318 and another neuron of the neural network all have the same weight w_{b}. The values of the weights w_, w₊ and w′ clearly describe the relative deviation of the strength of the respective links from a mean value w_{b}=1.

The weights not yet defined are referred to as follows:

wₙₛ₁ is the weight of the links from a neuron from the non-selective neuron pool 313 to a neuron from a context neuron pool 304, 305 or to a neuron from an output neuron pool 306, 307.

Wₙₛ₂ is the weight of the links from a neuron from the non-selective neuron pool 313 to a neuron from a combinational logic neuron pool 308, 309, 310, 311.

w₁ is the weight of the links from a neuron from a combinational logic neuron pool 308, 309, 310, 311 to a neuron from a context neuron pool 304, 305 or an output neuron pool 306, 307, the combinational logic neuron pool 308, 309, 310, 311 and context neuron pool 304, 305 or combinational logic neuron pool 308, 309, 310, 311 and output neuron pool 306, 307 not corresponding to the same type of information, as defined above.

w₂ is the weight of the links from a neuron from a context neuron pool 304, 305 or an output neuron pool 306, 307 to a combinational logic neuron pool 308, 309, 310, 311, the context neuron pool 304, 305 and combinational logic neuron pool 308, 309, 310, 311 or output neuron pool 306, 307 and combinational logic neuron pool 308, 309, 310, 311 not corresponding to the same type of information, as defined above.

The weights wₙₛ₁, wₙₛ₂, w₁ and w₂, are selected in a first embodiment such that wₙₛ₁=w₁ and wₙₛ₂=w₂. Suitable selection of the weights wₙₛ₁, wₙₛ₂, w₁ and w₂ allows stability of the overall input of each neuron to be achieved. The weights wₙₛ₁, wₙₛ₂, w₁ and w₂ are therefore referred to as balancing weights. In this embodiment they are determined according to the following equations:
wₙₛ₁=w₁=(1−fw₊−2fw′−2fw_)/((1−8f)+4f) (12)
wₙₛ₂=w₂=(1−fw₊−2fw′−3fw_)/((1−8f)+2f) (13)

It should be noted that wₙₛ₁ and wₙₛ₂ are different, the reason being that neurons from different neuron pools have a different number of links with the weight w_ and therefore the balancing weights are also different, in order to achieve stability of the overall input.

In another embodiment a value is assigned to the weights w₁ and w₂, which is not greater than w_{b}. A possible function effect of the links with the weights w₁ and w₂ can thereby be achieved. In this embodiment only the weights wₙₛ₁ and wₙₛ₂ are calculated, so that the sum of the weights of the links is to a neuron from a selective neuron pool 1.

Stability of the overall input of each neuron is thereby achieved.

The weights wₙₛ₁ and wₙₛ₂ are given by the following equations:
wₙₛ₁=(1−fw₊−2fw′−fw_{—}−4fw₁)/(1−8f) (14)
wₙₛ₂=(1−fw₊−2fw′−3fw_{—}2fw₂)/(1−8f) (15)

The weights wₙₛ₁, wₙₛ₂, w₁ and w₂ are selected in both embodiments just described such that the sum of the weights of the links is to a neuron from a selective neuron pool 1. This means that the values of the weights w−, w+ and w′ only have a weak influence on the activity state of the neural network 312, if no context data 315 and no data to be analyzed 314 is input, in other words if only the first component of the external input 316 is fed to each neuron of the neural network 312.

The neural network 312 used in the device for context-dependent data analysis 300 is based on a model for the prefrontal cortex of a monkey. The model is based on an experiment by Rainer, G., Asaad, W. F. & Miller, E. K., “Selective representation of relevant information by neurons in the primate prefrontal cortex”, Nature, 1998, vol. 393, pages 577-579, which is described briefly below. In this experiment monkeys carry out two different visual correspondence tasks. In the first of the two tasks, the array trial, an array of three objects arranged in three locations is shown to the monkey at the same time and in the other of the two tasks, the cue trial, only one object arranged in one location is shown to the monkey.

In the cue trial the monkey has to remember the identity and location of the object shown for a delay period, after which it is shown a new object in a new location. Then the monkey has to decide within the test period whether or not the location of the new object corresponds to the location of the object shown before and whether or not the new object corresponds to the object shown before. Cue trials are used to teach the monkey the identity of the object used as the target in array trials.

In an array trial the monkey has to identify the location of the target in an array it is shown and remember this location for a delay period. After this delay period the monkey is shown a new array and must decide whether the first array corresponds to the second array, i.e. whether the target is in the same location as in the array shown before. The respective locations of the two other objects shown are thereby irrelevant.

As the identities and locations of the objects, which were not the target, are irrelevant to the decision whether the new array corresponds to the array shown before, the monkey does not have to retain these in its working memory. In fact the recording of the activity of many neurons from the prefrontal cortex of the monkey shows that neuron activity is only influenced to a small degree by the presence of objects, which were not the target (see Rainer et al.). It can be concluded from this that the prefrontal cortex is involved in the mechanisms of context-dependent access to the working memory, which is deemed essential for cognitive functions.

Use of the device for context-dependent data analysis 300 is described below with reference to an example. The influence of different parameters on the response of the neural network 312 is also described. The mean field approximation is described first, as derived from the mean field approximation inserted in Brunel et al., and used to obtain some of the results described below. With the mean field approximation it is assumed that the neural network 312 is in a steady state.

The potential of a neuron is calculated according to the equation

$${τ}_{x} \frac{ⅆ V ( t )}{ⅆ t} = - V ( t ) + {μ}_{x} + {σ}_{x} \sqrt{{τ}_{x}} η ( t ) \qquad ( 16 )$$

where V(t) is the (membrane) potential of the neuron, the index x is used to refer to the neuron group under consideration, μₓ is the mean value for the potential of the neurons from the neuron group under consideration, if firing and fluctuations do not occur, σₓ measures the extent of the fluctuations and η is a Gaussian process with a correlation function that decreases in an absolutely exponential manner with the time constant τ_{AMPA}.

The variables μₓ and σₓ² are given by:

$$\begin{matrix}{μ}_{x} = \frac{( {T}_{ext} {v}_{ext} + {T}_{AMPA} {n}_{x} + {ρ}_{1} {N}_{x} ) {V}_{E} + {ρ}_{2} {N}_{x} 〈 V 〉 + {T}_{I} {w}_{I , x} {v}_{I} {V}_{I} + {V}_{L}}{{S}_{x}} & ( 17 ) \\ {σ}_{x}^{2} = \frac{{{g}_{AMPA , ext}^{2} ( 〈 V 〉 - {V}_{E} )}^{2} {N}_{ext} {v}_{ext} {τ}_{AMPA}^{2} {τ}_{x}}{{g}_{m}^{2} {τ}_{m}^{2}} & ( 18 )\end{matrix}$$

where w_{I,x} is the weights of the links from a neuron from the inhibitory neuron pool 318 to a neuron from the neuron pool with the reference x, vₑₓₜ=3 Hz, v_{I} the firing rate of the neurons of the inhibitory neuron pool 318, τₘ=Cₘ/gₘ the values of the excitatory and inhibitory neurons, which are a function of the neuron pool under consideration, and the other variables are given by the following equations:

$$\begin{matrix}{S}_{x} = 1 + {T}_{ext} {v}_{ext} + {T}_{AMPA} {n}_{x} + ( {ρ}_{1} + {ρ}_{2} ) {N}_{x} + {T}_{I} {w}_{I , x} {v}_{I} & ( 19 ) \\ τ = \frac{{C}_{m}}{{g}_{m} {S}_{x}} & ( 20 )\end{matrix}$$

where p is the number of excitatory neuron pools, fₓ the proportion of neurons in the excitatory neuron pool x, w_{j,x} the weight of the links between neurons from the neuron pool x and neurons from the neuron pool j, vₓ the firing rate of the excitatory neuron pool x,γ=[Mg⁺⁺]/3,57, β=0,062 and the mean membrane potential (Vₓ) has a value between −55 mV and −50 mV.

The firing rate of a neuron pool as a function of the defined variables is given by:
vₓ=ø(μₓ,σₓ) (33)
where

$$\begin{matrix}ϕ ( {μ}_{x} , {σ}_{x} ) = {( {τ}_{rp} + {τ}_{x} {\int }_{β ( {μ}_{x} , {σ}_{x} )}^{α ( {μ}_{x ,} {σ}_{x} )} ⅆ u \sqrt{π} exp ( {u}^{2} ) [ 1 + erf ( u ) ] )}^{- 1} & ( 34 ) \\ α ( {μ}_{x} , {σ}_{x} ) = \frac{( {V}_{thr} - {μ}_{x} )}{{σ}_{x}} ( 1 + 0 , 5 \frac{{τ}_{AMPA}}{{τ}_{x}} ) + 1 , 03 \sqrt{\frac{{τ}_{AMPA}}{{τ}_{x}}} - 0 , 5 \frac{{τ}_{AMPA}}{{τ}_{x}} & ( 35 ) \\ β ( {μ}_{x} , {σ}_{x} ) = \frac{( {V}_{reset} - {μ}_{x} )}{{σ}_{x}} & ( 36 )\end{matrix}$$

where erf(u) is the error function and τᵣₚ the refractory period, which is 2 ms for excitatory neurons and 1 ms for inhibitory neurons.

To solve the equations defined by (33) for all x, (32) is integrated numerically and solves the following differential equation, which has fixed point solutions, which solve the equations defined by (33):

$${τ}_{x} \frac{ⅆ {v}_{x}}{ⅆ t} = - {v}_{x} + ϕ ( {μ}_{x} , {σ}_{x} ) \qquad ( 37 )$$

The example described below corresponds to an array trial in the experiment described above. The target object, i.e. the context, is provided in this example by the first object. Qualitatively identical results would be achieved, if the context were provided by the second object. Accordingly in this example the first and third components of the external input 316 are fed to the first context neuron pool 304, as described above.

The data to be analyzed 314, which corresponds to the array shown in the experiment described above, in this example contains the information that the first object is at the first location and the second object is at the second location. Accordingly in this example the first and second components of the external input 304 are fed to the first combinational logic neuron pool 308 and the fourth combinational logic neuron pool 311, as described above.

The results are obtained in two steps in this example. During the first step the context data 315 and the data to be analyzed 314 are fed to the device for context-dependent data analysis 300 in the manner described above. During the second step the context data 315 and the data to be analyzed 314 are not fed on to the device for context-dependent data analysis 300. The activity of the neurons of the neural network 213 is examined during the second step.

In this example the context is provided by the first location. As the data to be analyzed 314 contains the information that the first object is at the first location, if the weights of the links of the neural network 312 have been selected appropriately, the device for context-dependent data analysis 300 outputs output data 317, which specifies the first location.

The procedure described corresponds to a simulation of the array trial in two steps. The first step corresponds to the period, during which the monkey is shown the array. The second step corresponds to the delay period, during which the monkey must remember the information required to carry out the task.

As described, the results below were calculated using a mean field approximation. The mean field equations above were solved using Euler's method with a step size of 0.2 and 5000 iterations, with which convergence was always achieved.

To obtain the steady state solution, which corresponds to the supplied context data 315 and the data to be analyzed 314, all excitatory neurons are initialized with the frequency 3 Hz and neurons from the inhibitory neuron pool 318 with the frequency 9 Hz. These values correspond to the attractors of the two different types of neuron, when only the first component of the external input 316 is fed to the neural network 312, i.e. when no context data 315 and no data to be analyzed 314 is fed to the device for context-dependent data analysis 300.

At the start of the second step all neurons with the steady state solutions obtained from the first step are initialized.

The results shown below and the frequencies specified either represent regular firing rates of the neurons during the delay period or are combinations of the values of the same status variables for a plurality of neuron groups, for example a mean value for the firing rate of a plurality of neurons.

The weights and the external input were first selected according to the following default values:
w′=1,8;w_{—}=0,3;w₊=2,1; λₛₜᵢₘ=50 Hz;λ_{bias}=20 Hz.

The impact of these parameters on the response of the neural network 312 was examined, by modifying one or two of the above parameters, while retaining the default values for the others.

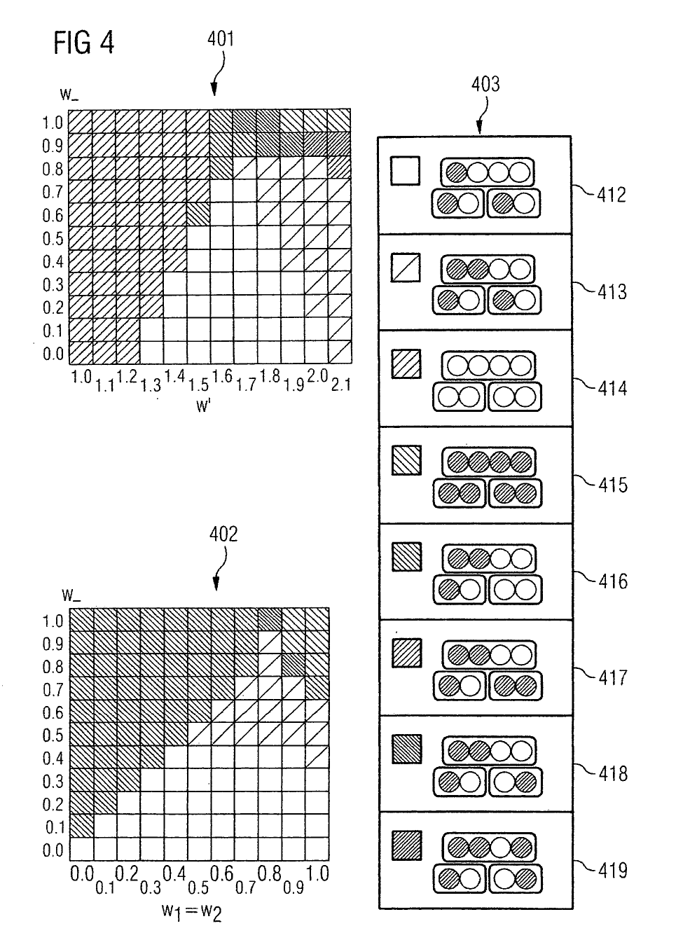

FIG. 4 illustrates the response of the neural network 312 as a function of the parameters w_, w′ and w1=w2. The first graphic diagram 401 illustrates the response of the neural network 312 as a function of the parameters w_ and w′. The second graphic diagram 402 illustrates the response of the neural network 312 as a function of the parameters w_ and w₁=w₂. The first graphic diagram 401 illustrates the response of the neural network 312 for values of the parameter w_ from 0 to 1 in steps of 0.1 and for values of the parameter w′ from 1 to 2.1 in steps of 0.1. The second graphic diagram 402 illustrates the response of the neural network 312 for values of the parameter w_ from 0 to 1 in steps of 0.1and for values of the parameter w₁=w₂ from 0 to 1 in steps of 0.1. In both graphic diagrams 401 and 402 the parameter w_ is plotted upwards.

An operating mode of the neural network 312 is defined by the activities of the eight selective neuron pools 304 to 311. On the right of FIG. 4 is a schematic diagram of the operating modes 403 of the neural network 312. The schematic diagram of the operating modes 203 shows eight schematic diagrams of an operating mode 412 to 419. The schematic diagrams of an operating mode 412 to 419 are based graphically on FIG. 3:

The four combinational logic neuron pools 308 to 311 correspond to the four circles in the upper row of a schematic diagram of an operating mode 412 to 419, the four circles corresponding from left to right to the first combinational logic neuron pool 308, the second combinational logic neuron pool 309, the third combinational logic neuron pool 310 and the fourth combinational logic neuron pool 311.

The two context neuron pools 304 und 305 correspond to the two circles on the left in the lower row of a schematic diagram of an operating mode 412 to 419, the two left circles corresponding from left to right to the first context neuron pool 304 and the second context neuron pool 305.

The two output neuron pools 304 and 305 correspond to the two circles on the right in the lower row of a schematic diagram of an operating mode 412 to 419, the two right circles corresponding from left to right to the first output neuron pool 306 and the second output neuron pool 307.

Each of the selective neuron pools 304 to 311 is in one of two states according to its activity: a state of high activity during the delay period in the case of an activity corresponding to a frequency of more than 10 Hz; or a state of low activity, which corresponds to spontaneous activity and a frequency of below 10 Hz.

A circle corresponding to a neuron pool in the first state is shown in gray in FIG. 4. A circle corresponding to a neuron pool in the second state is shown in white in FIG. 4. A first operating mode of the neural network 312 is characterized in that the data to be analyzed 314 is analyzed correctly according to the context specified by the context data 315.

The neuron pool corresponding to the first location, which is the first output neuron pool 306, has a high level of activity, even though only the first component of the external input 316, i.e. the spontaneous background activity, is fed to the neurons of the first output neuron pool 306, as described above. The high level of activity of the first output neuron pool 306 is due to the supply of the context data 315 and the data to be analyzed 314.

In the experiment described above, the context corresponds to the knowledge which of the two objects is the target object, which is represented by the fact that the second component of the external inputs 316 is fed to the first context neuron pool 304, as described above.

The first operating mode can be interpreted such that the result of the competition between the context neuron pools 304 and 305, in which the first context neuron pool 304 can be seen to have an advantage due to the second component of the external input, which can be interpreted as a so-called “bias”, which is fed to the first context neuron pool 304, is passed correctly to the output neuron pools 306 and 307. The first output neuron pool 306 clearly “wins” the competition with the second output neuron pool 307.

The bias, which provides information about the identity of the target object, thus determines the winner of the neuron pools, which correspond to a different type of information, namely location information.

In the first operating mode the first context neuron pool 304, which corresponds to the first object and in this example is the “target object”, also has high level of activity. The first operating mode is shown in FIG. 4 by the first schematic diagram of an operating mode 412 and in the two graphic diagrams 401 and 402 by a white box.

The second operating mode is shown in FIG. 4 by the second schematic diagram of an operating mode 413 and in the two graphic diagrams 401 and 402 by a white box with a diagonal line. The second operating mode is similar to the first operating mode. In the second operating mode the competition is also passed correctly to the output neuron pools.

The second operating mode differs from the first operating mode, in that not only is the first combinational logic neuron pool active, i.e. it has a high level of activity, but the second combinational logic pool is also active. This can clearly be interpreted such that the bias determines which combinational logic neuron pools have a high level of activity.

The third operating mode is shown in FIG. 4 by the third schematic diagram of an operating mode 414 and in the two graphic diagrams 401 and 402 by a light-gray box.

The fourth operating mode is shown in FIG. 4 by the fourth schematic diagram of an operating mode 415 and in the two graphic diagrams 401 and 402 by a light-gray, hatched box.

The third operating mode and the fourth operating mode can clearly be interpreted such that no neuron pool wins the inhibitorily mediated competition. In the third operating mode none of the selective neuron pools 304 to 311 has a high level of activity. According to the experiment described above, this can clearly be interpreted such that the monkey does not remember anything.

In the fourth operating mode each of the selective neuron pools 304 to 311 has a high level of activity. According to the experiment described above, this can clearly be interpreted such that the monkey remembers all the information.

The fifth operating mode is shown in FIG. 4 by the fifth schematic diagram of an operating mode 416 and in the two graphic diagrams 401 and 402 by a mid-gray box.

The sixth operating mode is shown in FIG. 4 by the sixth schematic diagram of an operating mode 417 and in the two graphic diagrams 401 and 402 by a mid-gray, hatched box.

The fifth and sixth operating modes can clearly be interpreted such that the two output neuron pools 306 and 307 do not compete with each other. This means that the feeding of context data 315 specifying the target object and of data to be analyzed 314 specifying the array to the neural network 312 does not cause competition between the two output neuron pools 306 and 307, each of which has the same state in the fifth and sixth operating modes.

According to the experiment described above, this can clearly be interpreted such that the monkey does not remember either of the two locations (fifth operating mode) or that the monkey remembers both locations (sixth operating mode), regardless of the position of the target object in the array shown.

In the fifth operating mode and in the sixth operating mode the first context neuron pool 304, the first combinational logic neuron pool 308 and the second combinational logic neuron pool 309 have a high level of activity, therefore are clearly the overall winners in the neural network 312. In the fifth operating mode the two output neuron pools 306 und 307 have a low level of activity. In the sixth operating mode the two output neuron pools 306 and 307 have a high level of activity but as in the fifth operating mode their response is clearly not determined by competition.

The seventh operating mode is shown in FIG. 4 by the seventh schematic diagram of an operating mode 418 and in the two graphic diagrams 401 and 402 by a dark gray box.

The eighth operating mode is shown in FIG. 4 by the eighth schematic diagram of an operating mode 419 and in the two graphic diagrams 401 and 402 by a dark gray, hatched box.

The fifth and sixth operating modes can clearly be interpreted such that the second output neuron pool 307 wins the competition between the two output neuron pools 306 and 307. The competition is therefore clearly passed incorrectly to the two output neuron pools 306 and 307. According to the experiment described above, this can clearly be interpreted such that the monkey remembers the location of the object, which is not the target object.

In the seventh operating mode and in the eighth operating mode the first context neuron pool 304 has a high level of activity. The eighth operating mode differs from the seventh operating mode in that the fourth combinational logic neuron pool 311 also has a high level of activity in addition to the first combinational logic neuron pool 308 and the second combinational logic neuron pool 309.

The first graphic diagram 401 shows the dependence of the response of the neural network 312 on the values of the weights w_ and w′. The weight w′ can clearly be interpreted such that it brings about cooperation between neuron pools, which correspond to some degree to the same information. Thus the weight w′ clearly serves to pass on the activity via the neural network 312.

It can be seen from the first graphic diagram 401 that the weight w′ must have at least the value 1.3, so that graphically speaking the competition is passed along the context module 301, the combinational logic module 302 and the output module 303. The weight w primarily brings about the competition in the neural network 312. The competition response is shown to increase, as w− decreases.

To ensure the correct mode of operation of the device for context-dependent data analysis 300, the values selected for w′ and w_ should not be too low, as shown by the first graphic diagram 401. This can clearly be interpreted such that both cooperation (relatively high w′) and competition (low w_) are required.

To ensure the correct mode of operation of the device for context-dependent data analysis 300 with a low w′, the value selected for w_ must be close to zero, as shown by the first graphic diagram 401. If there is an increase in w′ (specifically if there is an increase in cooperation), w_ can be increased (the competition can specifically be reduced), without the correct mode of operation of the device for context-dependent data analysis 300 being lost.

The second operating mode of the neural network 312 occurs at higher values of w′ and w_ compared with the first operating mode of the neural network 312. Specifically this can be interpreted such that for a high level of cooperation or low level of competition the bias does not allow one of the combinational logic neuron pools 308 to 311 to win.

With mean values of w′, i.e. values between 1.6 and 1.7, and a value for w_ close to 1 (specifically a low level of competition) the fifth operating mode occurs. This means specifically that there is no competition between the output neuron pools. According to the experiment described above, this can clearly be interpreted such that the monkey does not remember any location information.

With high values of w′ and w operating modes occur, in which the competition is clearly passed incorrectly to the output neuron pools 306, 307 or the fourth operating mode occurs, in which all selective neuron pools 304 to 311 have a high level of activity.

Following is a clear interpretation of the results shown in the second graphic diagram 402. For competition to occur between the output neuron pools 306 and 307, the value of the weight w_ must be less than or equal to the values of the weights w₁ and w₂. If the value of w₁=w₂ is less than w_, the competition between the three groups of selective neuron pools 304 to 311, i.e. between the combinational logic module, the context module and the output module, is dominant compared with the competition between neuron pools belonging to the same module 301, 302, 303.

In this instance the first context neuron pool 304, the first combinational logic neuron pool 308 and the second combinational logic neuron pool 309 are the overall winners of the neural network 312 and the competition between the output neuron pools 306 and 307 does not determine the activity of the two output neuron pools 306 and 307. In this situation there is no selective retention of location information as determined by information about the target object.

For the first output neuron pool 306 to have a high level of activity, the value selected for the weight w must below. The precise values of w₁ and w₂ appear not to influence the response of the neural network 312, as long as they are above w_ and below 1. Therefore to examine the dependence of the neural network 312 on parameters, w₁=wₙₛ₁ and w₂=wₙₛ₂ were selected according to the equations (12) and (13).

If the parameters w₁=w₂ and w′ have high values within the value range, in which the competition is passed correctly to the output neuron pools 306 and 307, the second combinational logic neuron pool 309 as well as the first combinational logic neuron pool 308, the first context neuron pool 304 and the first output neuron pool 306 have a high level of activity, i.e. the second operating mode occurs.

If w_ and w₁=w₂ have values close to 1, the competition is passed incorrectly to the output neuron pools 306 and 307 or all selective neuron pools 304 to 311 have a high level of activity.

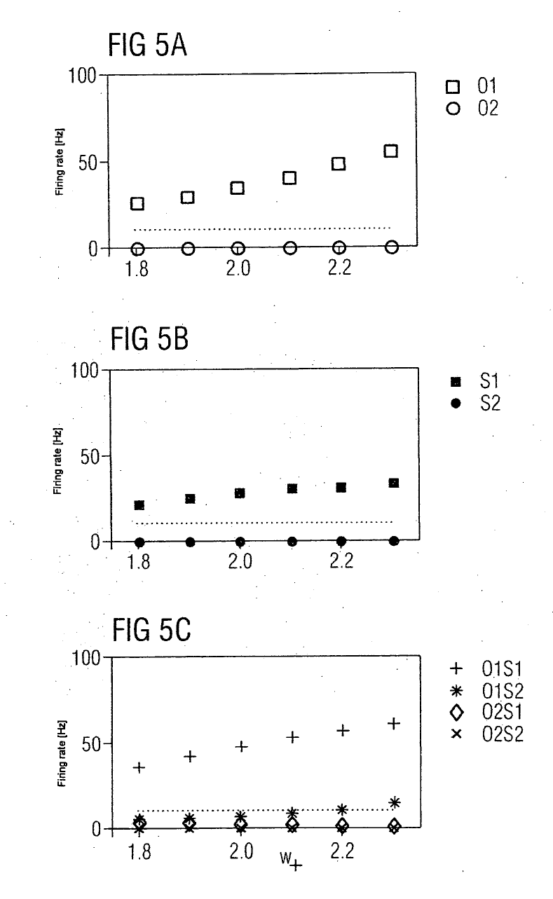

FIGS. 5(a), 5(b), 5(c) illustrate the response of the neural network 312 as a function of the value of the weight w+. The response of the neural network 312 is illustrated for values of the parameter w₊ from 1.8 to 2.3 in steps of 0.1.

The value 1.8 is the default value for w′. This can be interpreted such that neurons that store the same information from the data to be analyzed 314 are more closely linked than neurons, which only store some of the same information from the data to be analyzed 314.

The activity of the selective neuron pools is illustrated as a function of w₊. The parameter w₊ is plotted to the right.

FIG. 5(a) shows the mean firing rate of the context neuron pool as a function of w₊. The mean firing rate of the neurons of the first context neuron pool 304 is shown by a white box. The mean firing rate of the neurons of the second context neuron pool 305 is shown by a white circle.

FIG. 5(b) shows the mean firing rate of the output neuron pools as a function of w₊. The mean firing rate of the neurons of the first output neuron pool 306 is shown by a black box. The mean firing rate of the neurons of the second output neuron pool 307 is shown by a black circle.

FIG. 5(c) shows the mean firing rate of the combinational logic neuron pool as a function of w₊. The mean firing rate of the neurons of the first combinational logic neuron pool 308 is shown by an addition sign. The mean firing rate of the neurons of the second combinational logic neuron pool 309 is shown by a star. The mean firing rate of the neurons of the third combinational logic neuron pool 310 is shown by a white diamond.

The mean firing rate of the neurons of the fourth combinational logic neuron pool 311 is shown by a multiplication sign.

A clear interpretation of the response of the neural network 312 illustrated in FIG. 5(a), 5(b) and 5(c) is given below. For the considered values of w₊ the competition is passed correctly to the output neuron pools and the device for context-dependent data analysis 300 operates correctly.

The first combinational logic pool 304, the first output neuron pool 306 and the first combinational logic neuron pool 308 have a high level of activity in the delay period for all considered values of w₊. If w₊ has a value greater than or equal to 2.2, the second combinational logic neuron pool 309 also has activity in the delay period. The extent of the activity in the delay period increases as w₊ increases and is between 20 Hz and 60 Hz, which are values which are also biologically plausible.

The neuron pools, which do not have a high level of activity in the delay phase, have firing rates of few Hz. The influence of the value of the parameter λₛₜᵢₘ on the response of the neural network 312 was examined for values of λₛₜᵢₘ between 10 Hz and 550 Hz. For all considered values of λₛₜᵢₘ the first combinational logic pool 304, the first output neuron pool 306 and the first combinational logic neuron pool 308 have a high level of activity in the delay period for all considered values of w₊, the high level of activity only differing for the different neuron pools to the order of 0.1 Hz. The results of this examination can clearly be interpreted such that the selective memory effect is not a function of the considered values for λₛₜᵢₘ.

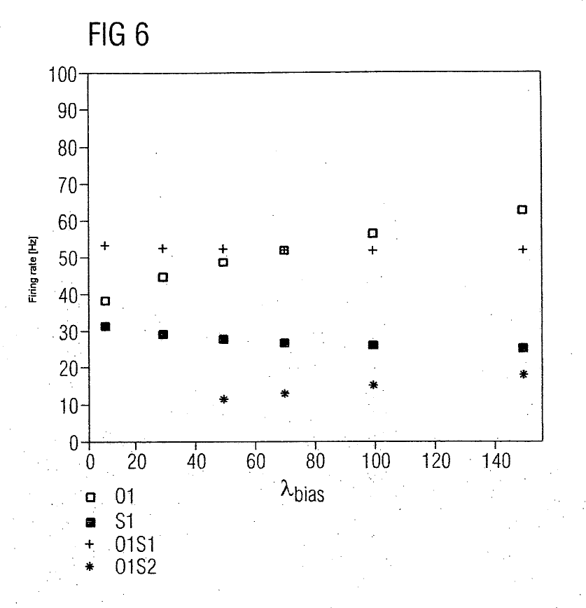

FIG. 6 illustrates the response of the neural network 312 as a function of the value of the parameter λ_{bias}. The response of the neural network 312 is illustrated for the following values of the parameter λ_{Bias}: 10 Hz, 50 Hz, 70 Hz, 100 Hz and 150 Hz. Only the activities during the delay phase of the selective neuron pools 304 to 311 are shown, corresponding to firing rates over 10 Hz.

The mean firing rate of the neurons of the first combinational logic neuron pool 308 is shown by an addition sign. The mean firing rate, of the neurons of the second combinational logic neuron pool 309 is shown by a star. The mean firing rate of the neurons of the first context neuron pool 304 is shown by a white box. The mean firing rate of the neurons of the first output neuron pool 306 is shown by a black box.

A clear interpretation of the response of the neural network 312 illustrated in FIG. 6 is set out below. For all values of λ_{bias} the first combinational logic pool 304, the first output neuron pool 306 and the first combinational logic neuron pool 308 show persistent activity. This means that the network has the capability to store location information based on the objective identity selectively, irrespective of the value used for the bias.

If the value of λ_{bias} is greater than or equal to 50 Hz, the second combinational logic neuron pool 309 also has a high level of activity during the delay period. In this instance the relatively large bias does not allow there to be only one winner out of the four competing combinational logic neuron pools 308 to 311.

If λ_{Bias} is zero, the selective memory effect does not occur. In this instance the first combinational logic neuron pool 308 and the second combinational logic neuron pool 309 have a higher level of activity than the third combinational logic neuron pool 310 and the fourth combinational logic neuron pool 311. Thus the first combinational logic neuron pool 308 and the second combinational logic neuron pool 309 win the competition between the combinational logic neuron pools 308 to 311, which is not passed to the context neuron pools 304 and 305 and the output neuron pools 306 and 307, as no context information is supplied by the bias.

The results of a simulation of the dynamic of the neural network are described below. These results are determined by simulation both for array trials and for cue trials. Equation (1) was solved numerically using a second order Runge-Kutta method with a step size of 0.01 ms. Each simulation was started after a period of 1000 ms, in which no context data 315 and no data to be analyzed 314 was supplied, in other words there was no stimulus during this period. Network stability could thereby be achieved.

This period was followed by a period of 750 ms, in which context data 315 and data to be analyzed 314 was supplied, in other words a stimulus was presented in this period. This was followed by a delay period of 1500 ms and a test period of 750 ms during both of which no data to be analyzed 314 was supplied.

This procedure corresponds to the procedure in the experiment described above. During the simulation of the array trials, a bias was constantly supplied, which provided information about the identity of the target object, i.e. context data 315 was constantly supplied. During the presentation of a stimulus, context data 315 and data to be analyzed 314 were supplied to the neural network 312 in the manner described above. The values of the parameters were selected according to the default values selected during the mean field analysis, apart from w′, which was selected as 1.6 and λₛₜᵢₘ, which was selected as 400 Hz. The weight w′ was selected as 1.6 to achieve activities during the delay period, which are similar to the activities measuring during the experiment described above.

It was described above that the value of λₛₜᵢₘ for the examined value range does not influence the results of the mean field analysis for the delay period. The value of λₛₜᵢₘ appears not to influence steady state conditions during the delay period but it appears to influence the dynamic in the neural network 312.

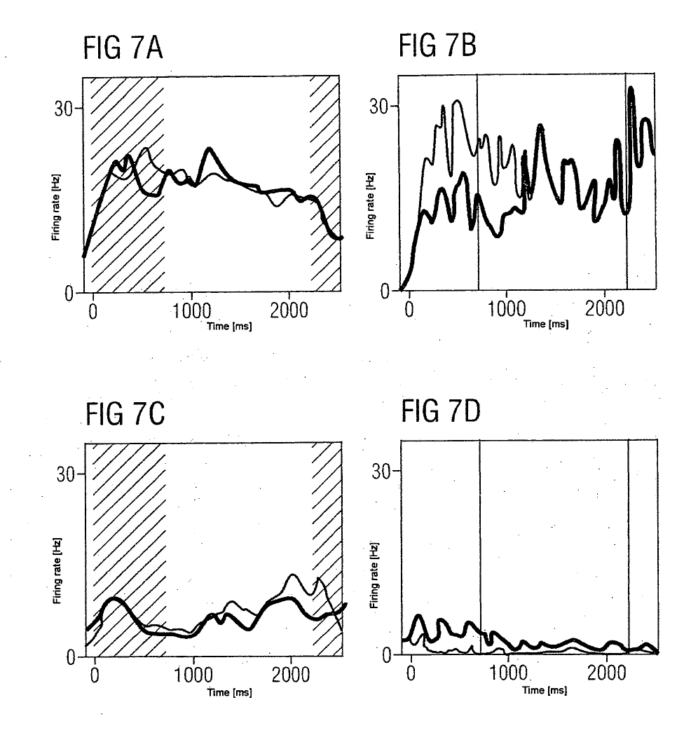

FIGS. 7(a), 7(b), 7(c), 7(d) illustrate the dynamic of the neural network 312. FIG. 7(a) shows the results measured during the experiment described above for a first array trial and a first cue trial. These results were reproduced according to Brunel et al. FIG. 7(b) shows the results of the simulation carried out for the first array trial and for the first cue trial. FIG. 7(c) shows the results measured during the experiment described above for a second array trial and a second cue trial. These results were reproduced according to Brunel et al. FIG. 7(d) shows the results of the simulation carried out for the second array trial and for the second cue trial.

The results corresponding to the array trials in FIGS. 7(a) to 7(d) are shown with thick lines while the results corresponding to the cue trials are shown with thin lines. FIGS. 7(a) and 7(b) show the results for an array trial, in which the first object is at the first location and the second object is at the second location and for a cue trial, in which the first object is at the first location. FIGS. 7(c) and 7(d) show the results for an array trial, in which the first object is at the second location and the second object is at the first location and for a cue trial, in which the first object is at the second location.

During the simulations, the results of which are shown in FIGS. 7(b) and 7(d), the data to be analyzed 314 fed to the neural network 312 contained the corresponding information. FIG. 7(a) and FIG. 7(c) show the mean firing rate measured by experiment over a plurality of trials for a single neuron (according to the procedure described in Rainer et al. for a single neuron in a monkey). The firing rate of this neuron during the delay period was high, when the target object was shown at a predefined location. This was irrespective of the identity of the object (see Rainer et al.) and therefore the neuron can be considered to be selective for the predefined location but activated by the identity of the object.

In order to allow a comparison of the results of the experiments with simulations, the simulated firing rates shown are always the mean firing rates of the neurons from the same output neuron pool, namely the first output neuron pool 306. During the simulations, the activity of a neuron was not averaged over a plurality of trials but activity was averaged over all the neurons of the first output neuron pool 306.

FIGS. 7(b) and 7(d) show the results of simulations for the two array trials and the two cue trials. The target object was the first object.

A clear interpretation of the results is given below. The simulations correspond closely to the experiments. The results show that knowledge of the identity of the target object can cause the location of the target object to be retained in the working memory. This can be concluded from a comparison of the thick lines in FIGS. 7(a) and 7(c) and the thick lines in FIGS. 7(b) and 7(d). Also the presence of objects irrelevant to the carrying out of the task set in the experiment had no influence on either the neural activity in the neural network 312 or the activity of the neuron considered in the experiment. This can be concluded by comparing the results corresponding to the array trials (shown by thick lines) with the results corresponding to the cue trials (shown by thin lines).

It is therefore demonstrated that activity of the neurons of the output module 303 in the delay period codes the position of the target object, irrespective of the presence of objects, which are not the target object, and irrespective of which object is the target object. The monkey appears not to retain any information about the objects, which are not the target object, in its working memory, the information being irrelevant for carrying out the task.

The invention can be deployed very appropriately in alternative applications, to simulate human perception processes and thought processes (in particular processes in the cerebral cortex, in particular in the prefrontal cortex and/or in the visual system of a human or more generally a more highly developed living being), in particular to examine and verify disease mechanisms in the human brain or more generally in the brain of a more highly developed living being.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1. A device for context-dependent data analysis with a neural network, comprising:
a context module with artificial context neurons grouped to form context neuron pools, each context neuron pool having at least one context-dependent input object assigned thereto;
an output module with artificial output neurons grouped to form output neuron pools, each output neuron pool having at least one output object assigned thereto; and
a combinational logic module with artificial logic neurons grouped to form combinational logic neuron pools, each combinational logic neuron pool having at least one context-independent input object assigned thereto and having at least a first neuron linked to at least one artificial context neuron and at least a second neuron linked to at least one output neuron, with weights of links between the artificial context neurons from different context neuron pools being less than the weights of the links between the artificial context neurons within a single context neuron pool, with the weights of the links between artificial output neurons from different output neuron pools being less than the weights of the links between neurons within a single output neuron pool, and the weights of the links between the artificial logic neurons from different combinational logic neuron pools being less than the weights of the links between the artificial logic neurons within a single combinational logic neuron pool.

2. A device according to claim 1, wherein each link between a first artificial logic neuron and a first the artificial context neuron also having a weight that is less than the weights of the links between the artificial context neurons within a single context neuron pool and the artificial logic neurons within a single combinational logic neuron pool.

3. A device according to claim 2, wherein each link between a second artificial logic neuron and a second artificial output neuron also having a weight that is less than the weights of the links between the artificial logic neurons from a single combinational logic neuron pool and the artificial output neurons within a single output neuron pool.

4. A device according to claim 3, wherein an assignment between the combinational logic neuron pools and the context-independent input objects is achieved by distributed representation.

5. A device according to claim 4, further comprising artificial inhibitory neurons grouped to form an inhibitory neuron pool, said artificial inhibitory neurons having an inhibitory effect on all other neurons of said device.

6. A device according to claim 5, further comprising artificial non-selective neurons grouped to form a non-selective neuron pool.

7. A device according to claim 6, wherein the weights of the links of the neural network are determined by a Hebbs' learning rule.

8. A device according to claim 7, wherein said device controls a production device, and
wherein each context-independent input object has a set of parameter values specifying settings of the production device required for production of a product, and each context-dependent input object specifies one product.
